(19) United States
(12) Patent Application Publication
(10) Pub. No.: US 2012/0096115 A1
(43) Pub. Date: Apr. 19, 2012

(54) Method and Apparatus Pertaining to Network-Facilitated Services

(76) Inventors: Brian Edward Anthony McColgan, Toronto (CA); Gaëlle Christine Martin-Cocher, Toronto (CA)

(21) Appl. No.: 13/273,559

(22) Filed: Oct. 14, 2011

Related U.S. Application Data
(60) Provisional application No. 61/393,258, filed on Oct. 14, 2010.

(51) Int. Cl. G06F 15/16

(52) U.S. Cl. 709/217

(57) ABSTRACT

A control circuit can extend presence information by including a service identifier element in the presence information, the service identifier element identifying a suite of services. Corresponding presence information that includes the service identifier element is transmitted to a watcher. By one approach the presence information further includes a version element defining a version of the suite of services. If desired, the presence information further includes a description element that is a human-readable string of characters that provides information about the suite of services.

### RELATED APPLICATION(S)

This application claims the benefit of U.S. Provisional application No. 61/393,258, filed Oct. 14, 2010, which is incorporated by reference in its entirety herein.

### TECHNICAL FIELD

This disclosed concept relates generally to networks and more particularly to network-based services.

### BACKGROUND

Modern wireless communications have grown considerably beyond merely supporting real-time voice communications between two parties. As wireless communications devices (such as so-called smartphones or tablets) increase their capacity and capabilities so grows their ability to support powerful productivity and social applications. End users, in turn, rely more and more upon these devices to manage their professional and private lives.

In many cases these communications devices rely upon, or are relied upon by, other platforms to access, inform, enable, or otherwise leverage such applications. In many cases these other platforms comprise elements of one or more networks to which the communications device couples. As one very simple example in these regards, many communications devices that have a native ability to determine their present geographic location (using, for example, an on-board global positioning system (GPS) receiver) will provide that location information to one or more presence servers. The latter, in turn, provide that information to other parties and applications (often referred to as watchers). In many cases this functionality occurs automatically and without requiring any specific interaction on the part of the end user.

Even as the number of services available in these regards continues to increase, however, so also grows a corresponding hierarchical structure and complexity. Consider, for example, the Global System of Mobile communications Association's (GSMA's) efforts to establish stronger links between mobile network operators (MNO's) (such as cellular telephony service providers) in order to foster greater interaction with respect to mobile wireless communication services via such efforts as the rich communication suite (RCS) that is intended to define an Internet-Protocol multimedia subsystem (IMS)-based suite of communications services. This suite of services is to include voice, chat, image/video sharing, presence, address book, and so forth.

RCS aims to encompass several different components, including image sharing, video sharing (via, for example, RCS v1.0 and v2.0), voice calling, messaging (SMS, IM, MMS), and social/Converged Address Book (CAB) services. It is likely that as RCS continues to evolve and incorporate additional service components (such as presence, location, social networking platforms, all-IP service elements, and so forth) that this collection of services will grow and change. Further, it will likely be a requirement that individual mobile network operators may wish to differentiate and select or vary the service components which make up a given release of RCS (in terms, for example, of components, versions supported, and so forth).

Unfortunately, the service-description/service instance relationship may not always be sufficient to deal with the complexity that attends such an approach. Examples in this regard include how RCS watchers will identify (utilizing presence information) another RCS user in such an application setting, how RCS clients will receive presence status relevant only to RCS (i.e., as a unit), and how a device or service consuming presence status will be able to determine service capabilities that a particular RCS component requires.

### BRIEF DESCRIPTION OF THE DRAWINGS

FIG. 1 comprises a schematic hierarchical diagram as configured in accordance with various embodiments of the disclosed concept;

FIG. 2 comprises a schematic diagram as configured in accordance with various embodiments of the disclosed concept;

FIG. 3 comprises a schematic diagram as configured in accordance with various embodiments of the disclosed concept;

FIG. 4 comprises a schematic diagram as configured in accordance with various embodiments of the disclosed concept;

FIG. 5 comprises a schematic diagram as configured in accordance with various embodiments of the disclosed concept;

FIG. 6 comprises a schematic diagram as configured in accordance with various embodiments of the disclosed concept;

FIG. 7 comprises a schematic diagram as configured in accordance with various embodiments of the disclosed concept;

FIG. 8 comprises a call-flow diagram as configured in accordance with various embodiments of the disclosed concept; and

FIG. 9 comprises a block diagram as configured in accordance with various embodiments of the disclosed concept.

Elements in the figures are illustrated for simplicity and clarity and have not necessarily been drawn to scale. For example, the dimensions, relative positioning, or both of some of the elements in the figures may be exaggerated relative to other elements to help to improve understanding of various embodiments of the present disclosed concept. Also, common but well-understood elements that are useful or necessary in a commercially feasible embodiment are often not depicted in order to facilitate a less obstructed view of these various embodiments of the present disclosed concept. Certain actions or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to certain of these various embodiments a control circuit of choice can be configured to use a profile that characterizes a service suite of at least two network-based services in order to facilitate functionality of a service suite agent on a mobile device or on another network element of choice. By one approach these services are grouped into the service suite as a function of a unifying criterion despite one of the at least two network-based services being different from another one of the at least two network-based services. (As used herein, the expression “control circuit” will be understood to include a fixed-purpose hard-wired platform or essentially any partially or wholly programmable platform that is configured to carry out the steps, actions, or functions described herein. All of these architectural options are well known and understood in the art and require no further description here.)

The unifying criterion can vary with the application setting and the needs or opportunities that tend to characterize a given application setting. Examples include, but are not limited to, operating compatibly within a specific operating paradigm (such as within Facebook, within the rich communication suite (RCS), and so forth), the at least two network-based services being administered by a same enterprise, the at least two network-based services sharing a same service type, and the at least two network-based services supporting a same quality of service, to note but a few. These teachings will also accommodate combining various unifying criteria in these same regards. As an illustrative example, one could specify that the candidates are both Facebook applications as well as RCS capable. As another illustrative example in these regards, one could specify that the candidates are both within RCS and are at least a particular identified quality-of-service level.

In combination with the foregoing (or in lieu thereof, as desired), these teachings will also generally accommodate employing a control circuit of choice to use a presence information data formatted (PIDF) message to publish information regarding such a service suite of at least two network-based services to facilitate the functionality of a service suite agent (or agents) on a mobile device. By one approach, if desired, this published information can refer, at least in part, to one or more service tuples of choice.

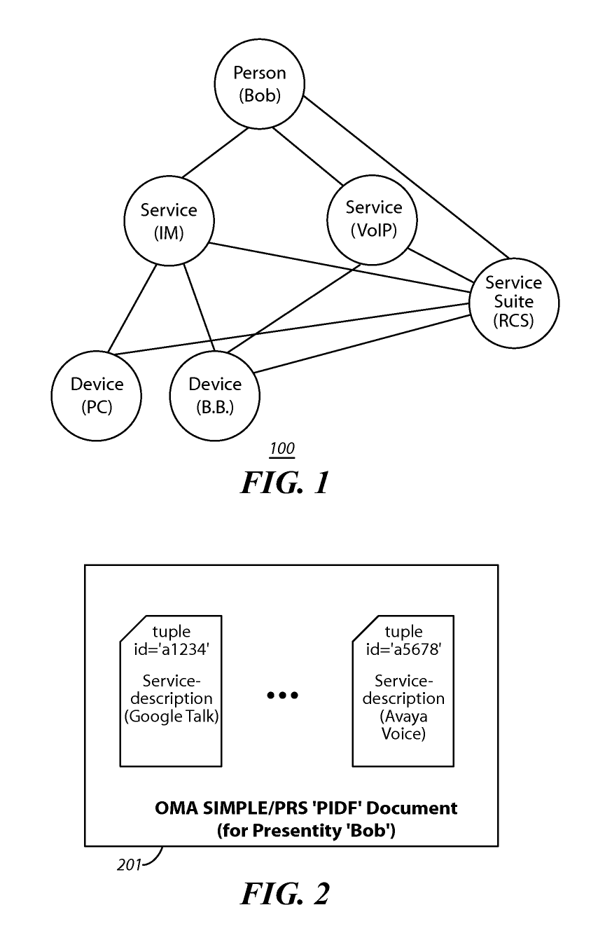

These and other benefits may become clearer upon making a thorough review and study of the following detailed description. Referring now to the drawings, and in particular to FIG. 1, it may be helpful to first describe a relevant problem statement. This example is based upon the Open Mobile Alliance's (OMA) Presence/SIMPLE standard. This enabler describes a mechanism by which a presence entity (often referred to as a “presentity”) may publish status/location information for one or more presence services. The presence service may store presentity status indicators and share specific presence indications (in the form of presence information) with other authorized users (i.e., watchers). Furthermore, another complimentary presence-based enabler (such as OMA's Presence Access Layer (PAL)) provides an easy-to-use, easy-to-consume interface by which watchers may receive and use presence information from a presence platform.

These enablers rely on a particular consistent presence information data format (PIDF). PIDF is a data model/format developed through the Internet Engineering Task Force (IETF) (see RFC 3863) and is defined using extensible XML schema. PIDF is focused on presence information blocks defined as tuples. PIDF establishes tuples at three distinct levels, these being the “person,” “service,” and “device” (see RFC 2778). Accordingly, a corresponding presence information document provides a data-model 100 for a presentity (such as a person denoted here as “Bob”) to realize status for “m” different services over “n” devices as shown in FIG. 1.

RCS (both client and application programming interface (API)) components make use of such a data model 100 to support RCS presence-related functionality. (Details in these regards are available at GSM Association, RCS SVD Release 4, “SVDG10_{—}021Rev1-2010-FN0011R01.doc.”) This includes functionality currently associated with a service. OMA has established a separate and distinct enabler, independent of transport protocols and presence platforms (see, for example, the OMA Presence Data Specification set forth at http://www.openmobilealliance.org), that defines element meta-data extensions as well as data-semantics for use in PIDF-formatted presence information documents. This meta-data includes a presence data extension (PDE) service-description element.

An illustrative example service tuple for presentity “Bob,” which incorporates an RCS-related service-description element, is provided below:

```
      <?xml version=“1.0” encoding=“UTF-8”?>
      <presence xmlns=“urn:ietf:params:xml:ns:pidf”
          xmlns:pdm=“urn:ietf:params:xml:ns:pidf:data-model”
      xmlns:rpid=“urn:ietf:params:xml:ns:pidf:rpid”
          xmlns:op=“urn:oma:xml:prs:pidf:oma-pres”
          xmlns:xsi=“http://www.w3.org/2001/XMLSchema-instance”
          entity=“sip:bob@xyz.org”>
        <tuple id=“a1232”>
        <op:willingness>
          <op:basic>open</op:basic>
        </op:willingness>
        <op:registration-state>active</op:registration-state>
        <op:service-description>
          <op:service-id>org.gsma.imageshare</op:service-id>
          <op:version>1.0</op:version>
          <op:description>RCS Image sharing
application</op:description>
        </op:service-description>
        <pdm:deviceID>urn:uuid:48662e19-5fbf-43fc-a2fd-
d23002787599</pdm:deviceID>
        <contact>sip:bob@imgshare.com</contact>
        <timestamp>2009-12-20T11:58:56Z</timestamp>
        </tuple>
        ...
```

In this example, presentity “Bob” publishes presence information pertaining to an RCS component (in particular, “image share”). The service identifier (i.e. the value underlined within child element service-id) referred to in Bob's presence information is defined and registered as part of the OMNA Service Description registry available at http://www.openmobilealliance.org/Tech/omna/omna-prs-PidfSvcDesc-registry.aspx.

Service identifiers are utilized in the body of one or more PIDF documents published by a presentity to assist in identifying and differentiating service tuples from one another. This aids a watcher when processing service related presence indications. FIG. 2 illustrates a more specific example in these regards. Here, a PIDF document 201 for presentity “Bob” illustrates different identifiers being used for different tuples that, in turn, correspond to different services (such as tuple identifier a1234 being used with the Google Talk service and tuple identifier a5678 being used with the Avaya Voice service). It should be understood, however, that a given presentity publication is not necessarily conveyed as-is to such a watcher by, for example, a presence server. For example, a given presentity may publish, say, three different PIDF documents that the presence server then consolidates to present a composite view of presence information for that presentity. This could involve, for example, including PIDF tuples from all three of these PIDF documents in the information provided to the watcher.

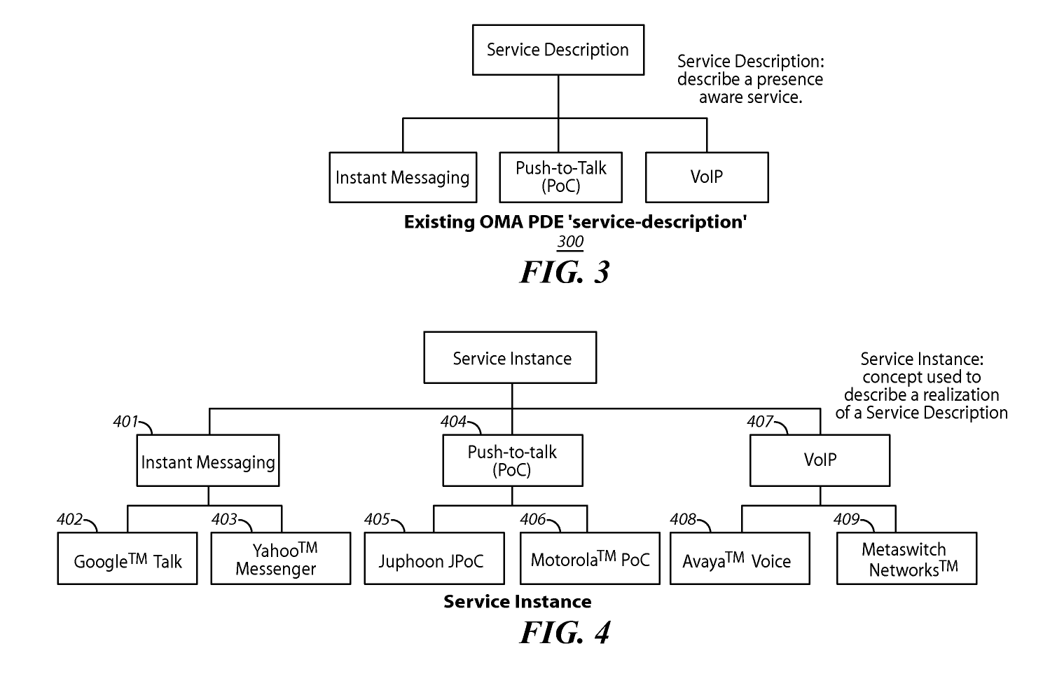

FIG. 3, in turn, provides a corresponding logical view of the service description portion 300 of such a service tuple. It may be noted that a service-description element typically only provides a logical description of a service. A service description realized within a network infrastructure and functioning on behalf of one or more users is commonly referred to as a service instance. Therefore, in many application settings the PIDF service tuple comprises the closest element (in PIDF) that models a user's presence status relative to a service instance.

It may further be noted that different service tuples (corresponding to different service instances) within a single PIDF presence document may in fact refer to the same service description for a single presentity. For example, and referring now to FIG. 4, it is possible that a wireless user (such as, in these examples, “Bob”) utilizes two distinct instances of an instant messaging service 401 such as both GoogleTalk™ 402 and Yahoo™ Messenger 403. As another illustrated example, this user utilizes two distinct instances of a push-to-talk service 404 (these being Juphoon JPoC 405 and Motorola™ PoC 406). And as yet another illustrated example in these same regards, this user utilizes two distinct instances of Voice over Internet Protocol (VoIP) 407 (these being Avaya™ Voice 408 and Metaswitch Networks™ 409).

The following example of “Bob's” PIDF document illustrates how two service tuples may refer to the same service description for distinct service instances. Here, the distinct service instance examples are GoogleTalk™ and Yahoo Messenger™ which realize presence status for presentity “Bob” over a single OMA compliant IM-session service description:

```
      <?xml version=“1.0” encoding=“UTF-8”?>
      <presence xmlns=“urn:ietf:params:xml:ns:pidf”
          xmlns:pdm=“urn:ietf:params:xml:ns:pidf:data-model”
      xmlns:rpid=“urn:ietf:params:xml:ns:pidf:rpid”
          xmlns:op=“urn:oma:xml:prs:pidf:oma-pres”
          xmlns:xsi=“http://www.w3.org/2001/XMLSchema-instance”
          entity=“sip:bob@xyz.org”>
        <tuple id=“a1234”>
        <op:willingness>
          <op:basic>open</op:basic>
        </op:willingness>
        <op:registration-state>active</op:registration-state>
        <op:service-description>
          <op:service-id>org.openmobilealliance:IM-
session</op:service-id>
          <op:version>1.0</op:version>
          <op:description>Google Talk</op:description>
        </op:service-description>
        <pdm:deviceID>urn:uuid:48662e19-5fbf-43fc-a2fd-
d23002787599</pdm:deviceID>
        <contact>sip:bob@gmail.com</contact>
        <timestamp>2010-12-20T11:58:56Z</timestamp>
        </tuple>
        <tuple id=“a5678”>
        <op:willingness>
          <op:basic>open</op:basic>
        </op:willingness>
        <op:registration-state>active</op:registration-state>
        <op:service-description>
          <op:service-id>org.openmobilealliance:IM-
session</op:service-id>
          <op:version>1.0</op:version>
          <op:description>Yahoo Messenger</op:description>
        </op:service-description>
        <pdm:deviceID>urn:uuid:48662e19-5fbf-43fc-a2fd-
d23002787599</pdm:deviceID>
        <contact>sip:bob@yahoo.com</contact>
        <timestamp>2010-12-20T10:32:56Z</timestamp>
        </tuple>
        ...
```

So configured, these teachings permit a distinction to be readily and clearly drawn between “a” service on the one hand and a collection of services on the other hand. Although such a paradigm runs contrary to prior practice in these regards, drawing and supporting this distinction in turn facilitates meeting many needs that are otherwise wholly or insufficiently unaddressed.

Generally speaking, these teachings fundamentally address the manner in which an operational paradigm such as a given RCS release is modeled and described as a suite of components. This approach, in turn, facilitates establishing a relationship between, for example, RCS, the RCS client, the RCS API, and the underlying service components. This can further include, by one approach, establishing a profile that permits a standards body (such as OMA) or a consortium (such as the GSMA) to specify mandatory and/or optional services that make up a given release of their operating paradigm (such as RCS)

One approach in these regards can be based on a service suite or class of service (as defined, for example, by the Open Mobile Alliance's Presence Access Layer at http://www.openmobilealliance.org). When present in a PIDF document, a service suite or class of service can refer to service instances making up a significant collection of components (corresponding, for example, to a particular release of RCS).

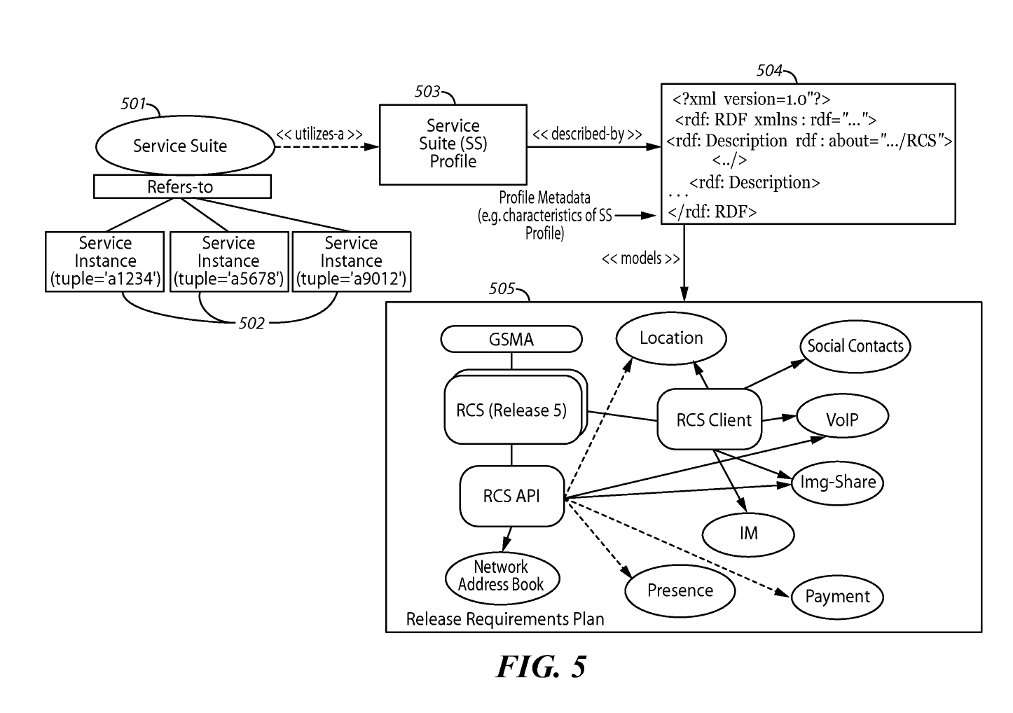

Using this approach, a service suite can comprise a derivation of a PIDF tuple element. Furthermore, and referring now to FIG. 5, a given service suite 501 (that comprises a plurality of service instances 502) can be associated, if desired, with a service suite (SS) profile 503. These teachings will also support comprising a service suite 501 of service descriptions (in lieu of service instances or in combination therewith). A service suite 501 made up of physical service instances (by tuple-id, for example) can comprise a physical configuration while a service suite 501 made up of logical service description elements can comprise a logical configuration. This could comprise, for example, having the service suite 501 refer to generic service descriptions (i.e., one for a VoIP service-description, a second for a PoC service-description, and a third an IM/Chat service-description).

This service suite profile 503 may be used independent of any specific protocol or data format to establish a set of characteristics 504 that describe the elements making up a given service suite. This profile may also include containment structures that, for example, could be utilized by a consortium (such as GSMA) or other organization to define release plans for collections of components, suites, APIs, and the like. For example, in the case of RCS, this approach may be utilized to describe an overall release plan 505 for RCS, such that the profile 503 subsequently contains, for example, more descriptive definitions or references to definitions relating to elements of the overall release (such as, for example, an RCS client, an RCS API, and so forth). This profile 503 may also be utilized by or on behalf of a network service vendor/provider to establish a suite of components required to deploy and realize a service within a given network (such as a wireless mobile network).

By one approach, the service suite or class of service extends existing PIDF/OMA PDE element definitions within a presence information document. For example a <service-suite> element can be defined to extend the service tuple and to further specify with additional data semantics. For example, if desired, the <service-suite> element may exist within a PIDF presence information document, may contain additional meta-data (that is associated with a service suite), and may refer to other service instances/tuples that may exist within the document. If other service instances or tuples do not exist, then in lieu of the foregoing or in combination therewith, this may be ignored. In this case, then, a watcher or document processor may continue to scan and process other referent service tuples provided by a presence service on behalf of a presentity.

By another approach, the consistency of the suite or class of service can be checked (over and above formatting/schemata considerations) on a stand-alone basis or by the watcher/processor utilizing the service suite/release profile that may be referred to either directly in the <service-suite> parent XML element, or as possibly available when provisioned separately (using, for example, local configuration, a SIM card, or some other mechanism). For example, if an RCS client service suite is required to have an instance of a <service-description> for an OMA compliant IM-session (as might be specified, for example, by a corresponding service profile) then this may result in specific actions by a watcher processor running on an end-user's mobile communications device. Alternatively, the service suite/release profile may also specify the actions that an entity such as a watcher client or watcher delegate (such as a PAL server) might need to interpret or execute as per the release profile instructions. As one illustrative example in these regards, such an action might be to prevent an RCS client from executing. Another illustrative example would be to request the RCS client downgrade to a previous release or version of the applicable application. Release profile instructions in turn could be incorporated as part of a service suite profile, or they could be configured separately.

A sample PIDF XML document that illustrates a service suite/class of service appears as follows (it being understood that this example serves purely in an illustrative capacity and is not intended to suggest any limitations in these regards). Note that in this example a class of service identifier serves to identify a class of service, that a service profile specifies details of a corresponding release, and that the service suite itself refers to service tuples/instances.

```
      <?xml version=“1.0” encoding=“UTF-8”?>
      <presence xmlns=“urn:ietf:params:xml:ns:pidf”
          xmlns:pdm=“urn:ietf:params:xml:ns:pidf:data-model”
      xmlns:rpid=“urn:ietf:params:xml:ns:pidf:rpid”
          xmlns:op=“urn:oma:xml:prs:pidf:oma-pres”
          xmlns:xsi=“http://www.w3.org/2001/XMLSchema-instance”
          entity=“sip:bob@xyz.org”>
        <service-suite id=”ss001”>
        <op:tuple-ref refID=”a1234”/>
        <op:tuple-ref refID=”a5678”/>
        <op:service-suite-description>
          <!-- Class of service identifier -->
          <op:class of service-id>com.gsmworld.rcs:1.0</op:class of
service-id>
<op:profile>http://www.gsmworld.com/rcs/ss_prof/rcs/rel1</os:profile>
          <op:version>1.0</op:version>
          <op:description>RCS Release 1</op:description>
        </op:service-description>
        <contact>sip:bob@gsmworld.com</contact>
        <timestamp>2010-12-19T15:22:08Z</timestamp>
        </service-suite>
        <tuple id=“a1234”>
        <op:willingness>
          <op:basic>open</op:basic>
        </op:willingness>
        ...
        </tuple>
        <tuple id=“a5678”>
        <op:willingness>
          <op:basic>open</op:basic>
        </op:willingness>
        ...
        </tuple>
      ...
```

It will be noted that in the PIDF presence information document example shown above, a watcher-client/processor may readily (1) determine which service instances a presentity has published presence status corresponding to a service suite or class of service; (2) identify another RCS user without having to scan through other service tuples; and (3) narrow examined presence information service tuples to only the relevant service tuples corresponding to the class of service (RCS specific service instances in this particular illustrative example).

Note also that as with regular service tuples, the <service-description> element contained within a <service-suite> element may be extended to also specify service suite capabilities. For example, one can take the XML-example provided above and repurpose the <op:service-id> element to represent a singular presence aware service, a presence aware service-suite, or a class of service (as regards, for example, an RCS client). A particular service-suite identity could be registered (for example, within an OMNA PIDF Service Registry) as “well known” or otherwise understood to mean a particular service suite without needing to directly depend on a service suite/release profile.

This, in turn, enables a watcher-client/processor to establish the overall capabilities for a service suite or class of service (for example, an RCS client suite) or conversely to discover and drill down to dependant service tuples for a class of service to establish per-service component/instance capabilities. Alternatively, the processor/watcher-client may also refer to the service suite (SS)/release profile to gain further (i.e., supplemental) information regarding the composition of a given release or suite.

As one result of defining a service suite for an instance of an actual composite collection of services, such as that described for a given RCS release, it is possible for example to establish indicators of presence relative to the service suite itself. For example, a presence-enabled client (such as a traditional OMA Presence/SIMPLE watcher client) can subscribe for the presence information corresponding to a given set of components making up an RCS release overall, as shown in the following example which illustrates RCS client Alice subscribing to the presence information of Bob (specifically in an RCS context).

```
SUBSCRIBE sip:bob@example.com SIP/2.0
Via: SIP/2.0/UDP example.com;branch=z9hG4bK12a034b1
To: <sip:bob@example.com>
From: <sip:alice@example.com>;tag=193423313771233
Call-ID: 32432udfidfjmk342
CSeq: 1234 SUBSCRIBE
Max-Forwards: 70
Expires: 3600
Contact: <sip:alice.client@example.com>
Content-Type: application/simple-filter+xml
Content-Length: ...
      <!- Event notification filter -->
      <?xml version=”1.0” encoding=”UTF-8”?>
      <filter-set xmlns=”urn:ietf:params:xml:ns:simple-filter”>
      <ns-bindings>
        <ns-binding prefix=”pidf” urn=”urn:ietf:params:xml:ns:pidf”/>
        <ns-binding prefix=”op” urn=”urn:oma:xml:prs:pidf:oma-pres”/>
      </ns-bindings>
      <filter id=”123” uri=”sip:bob@example.com”>
      <what>
        <include type=”xpath”>
        //op:service-suite/op:service-suite-description[op:class of
service-id=”MyFriendlyChat”]/pidf:status/pidf:basic
        </include>
        <include type=”xpath”>
        //op:service-suite/op:service-suite-description[op:class of
service-id=”MyFriendlyChat”]/op:willingness/op:basic
        </include>
        <include type=”xpath”>
        //op:service-suite/op:service-suite-description[op:class of
service-id=”MyFriendlyChat”]/pidf:contact
        </include>
        <include type=”xpath”>
        //op:service-suite/op:service-suite-description[op:class of
service-id=”MyFriendlyChat”]/pidf:timestamp
        </include>
      </what>
      </filter>
        </filter-set>
```

By one approach, a class of service or service suite/release profile may be described utilizing simple (name, value) pairs. In other cases it may utilize a binary or XML format. In yet other application settings it may be specified utilizing a series of RDF tuples. It should be noted that the service suite/release profile may also specify a cardinality of contained or referred-to components (such as “zero or more compliant IM services,” “at least two VoIP components with a service description of XYZ,” and so forth). These extended descriptions, as contained in the service suite/release profile, either in isolation or combination, permit human and/or computer/automata to establish an internal representation of a release.

Further, this proposed solution would permit a vendor, consortium such as the GSMA, or other standards organizations or agencies to:

deal with the complexity of releases (either in isolation) or based on hierarchies of other components (as may be the case with GSMA and RCS);

specify what is optional and what is mandatory for a given release;

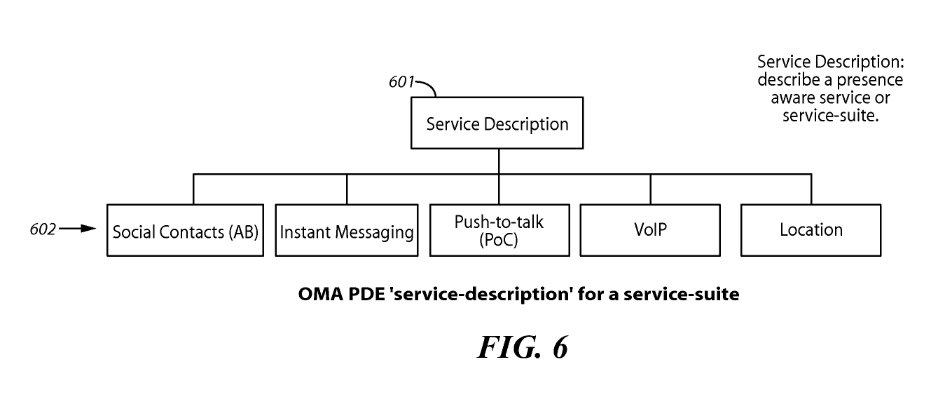

specify (optionally) cardinality of given components required to fulfill a given release as depicted in FIG. 6 (which illustrates a particular service description 601 as requiring a plurality of corresponding components such as social contacts, instant messaging, push-to-talk, VoIP, and location); and

specify actions or processes (using, for example, rules) to invoke if certain components or sub-hierarchies are not present in the corresponding information source (such as a PIDF presence information document) (where actions may include ignoring, falling back to an older release, setting a specific blanket indication of the user publishing the information (e.g. “the user has opted out of RCS”), or attempting to disable specific features).

These teachings will also accommodate permitting an organization to establish and evolve a release for a suite or set of products/components. For example, utilizing resource description framework (RDF) triples or a corresponding XML schema could be utilized to define and describe as part of a service suite profile, differences and evolutions between releases. For example, between RCS release 3 and 4 a format could be defined to indicate (as part of the SS/release profile) the components that are brand new, as well as components that have been updated or removed/replaced. This could summarize to the processor/watcher-client the specifics around a given release. Further, by indicating what is mandatory and what is optional, processors may choose whether the indicated presentity meets the corresponding attendant criteria to function at a specific level (for example, does user agent “Alice” conform to an RCS v1.0 release?).

Also if desired, a service suite profile may be stored and managed (including creation, retrieval, updating, and/or deletion) within a network-based document storage platform such as an XCAP or XDM server. This might comprise, for example, establishing a service suite application usage that is an XCAP/XDM XML schemata, associated data semantics, permissions, and constraints. With an XCAP/XDM app-usage for service suite profiles, it is possible to verbosely describe a given version or release of a corresponding service suite. This enables a service platform (such as a RESTful API exposing, for example, an RCS API) to expose different versions of a given RCS release as distinct interfaces, potentially at the same time.

By yet another approach, it is possible for a service suite profile application usage to be keyed or to otherwise encapsulate a service XUI (as defined in the aforementioned Open Mobile Alliance Presence Access Layer as described at http://www.openmobilealliance.org) such that it may be referenced when necessary. It may also be possible for a service suite profile to be derived (for example, either from the service XUI or based on other factors such as the resolved presence context identifier).

By way of illustration, the following SIP-based example makes of use of service XUI when requesting the establishment of a presence context by a PAL Client:

```
MESSAGE sip:pal@example.com SIP/2.0
Via: SIP/2.0/UDP alice.example.com:5060;branch=z9hG4bKn3ashds735
Max-Forwards: 70
To: <sip:friendlychat@example.com>
From: “Alice” <sip:alice@example.com>;tag=456348234
Call-ID: 843817637684230@3248sd23asdh09234
      CSeq: 126 MESSAGE
      P-Preferred-Identity: “Alice Smith” <sip:alice@example.com>
      Supported: gruu
      Accept: application/vnd.oma.pal+xml
      Contact: <sip:alice@example.com;gr=urn:uuid:f81d4fae-
7dec-11d0-a765-00a0c91e6bf6>
      Expires: 720
      Content-Length: 160
      Content-Type: application/vnd.oma.pal+xml
      <?xml version=“1.0” encoding=“UTF-8”?>
      <p1:pal-message xmlns:p1=“urn:oma:xml:prs:pal:payloads:1.0”>
      <p1:pal-request>
        <p1:pal-establish-pres-context service-id=“sip:rcs-
release2@gsma.org” palclient-
      id=“sip:alice@example.com” quality-of-service=“Gold”/>
        </p1:pal-request>
        </p1:pal-message>
```

In this example, the attribute ‘service-id’ within the presence context establishment request represents a service XUI (such as an XCAP user identity corresponding to a service entity) representation of the service suite and may be utilized by a PAL server to further retrieve, for example, a service suite profile to aid in establishing a presence context as suggested above. In addition it may allow a PAL server to establish underlying presence context based on service components contained or referenced by a given service suite profile. This may include, for example, constructing a composite presence context representing a combined view of presence for the service suite (for example, by consolidating aspects, rules, policy, and/or triggers of each of the service suites component parts—for example, video share, instant messaging, VoIP, and so forth).

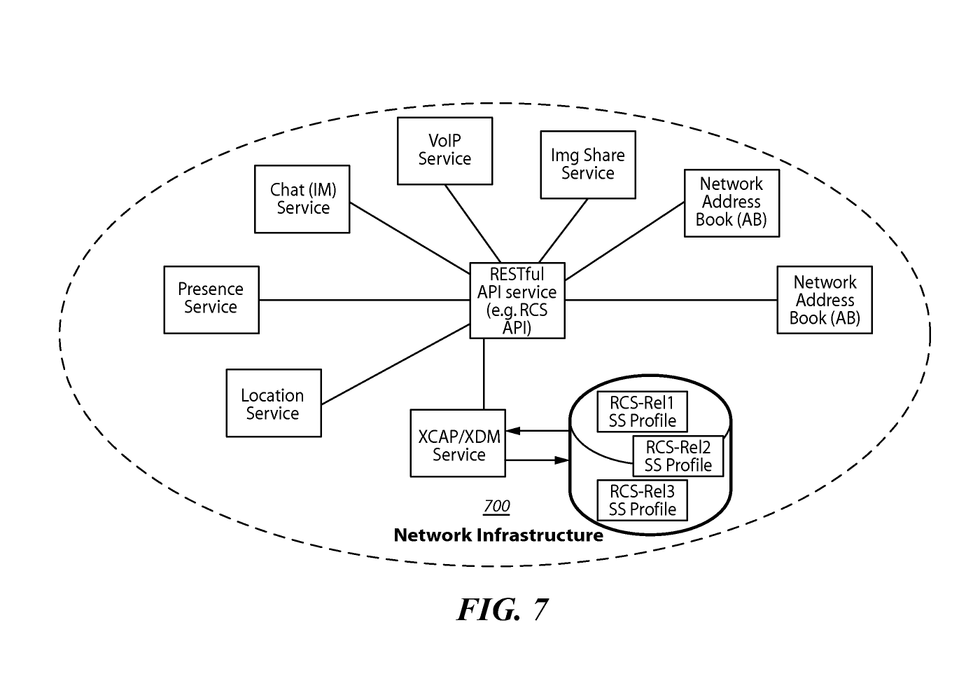

The service suite profile permits a description of the component hierarchy and corresponding characteristics completely independent of the PIDF format. If desired, the service suite profile application usage may be stored in a database supporting an XML datatype (such as an Oracle XML database) or the application usage may be transformed to a traditional normalized tabular structure and stored in a regular relational database system (such as a MySQL database). By way of illustration, FIG. 7 provides a detailed view of a network infrastructure 700 employing a variety of services that may be described and utilized by a service suite (for example, a RESTful API).

Further, it will be appreciated that a service suite profile permits a variety of network entities (for example, an RCS network component such as a RESTful API, and/or an RCS client) to access or expose underlying structure, capabilities, and characteristics of a service suite profile/class of service for a given release without having to subscribe or refer to a PIDF document stored within a presence platform. Accordingly, it becomes possible for a client (such as a client running in a personal computer within a corporate enterprise or on a mobile device connected by a radio access network to a mobile network infrastructure) to be authorized to access or retrieve the service suite profile. This may be useful, for example, to establish what sub-services an RCS client is going to interact with or what sub-services an RCS client must support for basic functionality and/or interoperability. For example, a simple (consumer) mobile RCS client may be able to choose which services (at a minimum) are to be employed to receive or utilize from on behalf of a given RCS suite.

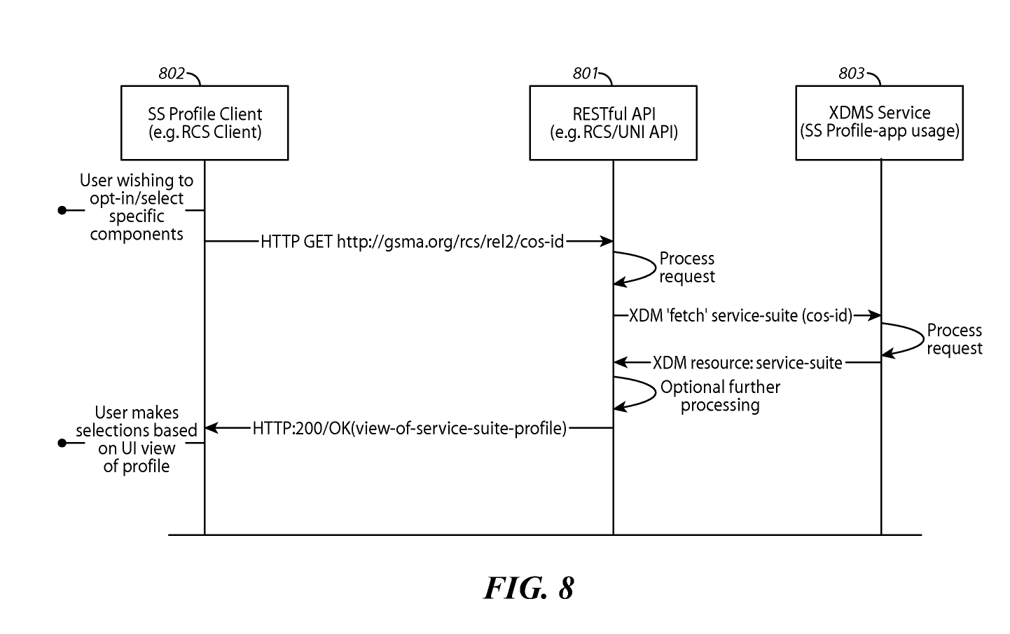

Further, in a corporate environment, the relevant administrator may wish to establish policy based on the composition, in terms of what RCS sub-components to expose (or restrict) on behalf of its employee/user base. FIG. 8 illustrates a logical message flow in these regards in the context of a RESTful API 801 (which may function as an XDM Client or XDM Agent) interacting with an RCS client 802 through use of a service suite profile via an XDMS service 803.

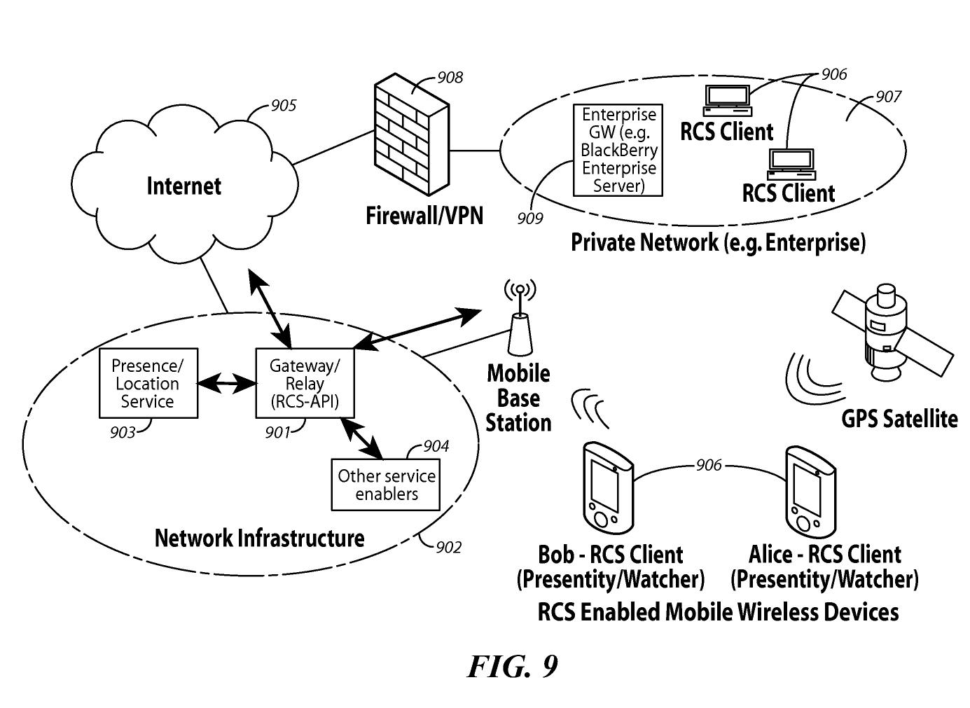

FIG. 9 illustrates one approach to an RCS-type network that can suitably implement these teachings An RCS-API gateway 901 is situated within the network infrastructure 902 and interconnects to a series of services including but not limited to a location/presence service 903 and possibly other service enablers 904 as well (such as an address book, packet-switched voice, instant messaging, and so forth). In this illustrative example this RCS-API gateway 901 also bidirectionally interconnects with an extranet (in this case, the Internet 905). This permits the RCS-API gateway 901 to provide and expose services utilizing interfaces from various Internet-Protocol Internet resources such as Facebook™, Twitter™, LinkedIn, to note but a few.

RCS clients 906 utilizing the RCS API may comprise, for example, end-consumer devices (such as platforms that connect in series with the mobile stations of a wireless mobile network operator) or enterprise devices (that reside, for example, in a private network 907 behind a secure firewall/VPN 908, which private network 907 possibly also includes an enterprise gateway 909. By one approach, any of these network elements (including the end-user platforms, the network infrastructure elements, the private network elements, and even servers or the like as may reside within the Internet itself) can comprise the aforementioned control circuit and hence can store (in whole or in part) one or more service suite profiles as described herein and/or use such a profile as per these teachings Similarly, any of these network elements can use one or more PIDF-formatted messages in order to publish information regarding one or more such service suites as taught above.

Pursuant to these teachings one can readily model a service-suite class of service based on one or more service tuples to thereby encapsulate a collection of service descriptions for subsequent exposure as an application or development suite. By one approach these teachings also permit the leveraging of XML and in particular PIDF to define a useful data format to encapsulate a service suite for use in platforms that utilize information services and that may be referred to and processed independently of a specific computing platform, application, service, or protocol. By permitting a service suite to be identified via a corresponding class of service identifier, these teachings are themselves then readily leveraged in various useful ways. This can include enabling various vendors, consortiums, and standards bodies to effectively release profiles that associate a service suite/release profile with a service suite. This could comprise, for example, identifying one or more standard identifiers as being “well known” recognizable service suites in an OMNA PIDF service/service suite registry independently of a service suite/release profile.

These teachings are highly flexible in practice and can be easily scaled to accommodate a wide variety and number of services and related components and elements. These approaches will also permit the leveraging of numerous legacy systems, protocols, and standards in a way that readily accommodates tomorrow's thinking and practices, particularly with respect to wireless computing devices such as so-called smartphones and the like.

Those skilled in the art will recognize that a wide variety of modifications, alterations, and combinations can be made with respect to the above described embodiments without departing from the spirit and scope of the disclosed concept, and that such modifications, alterations, and combinations are to be viewed as being within the ambit of the inventive concept.

We claim:

1. A method comprising:
extending presence information by including a service identifier element in the presence information, the service identifier element identifying a suite of services; and
transmitting to a watcher, after the extending, the presence information that includes the service identifier element.

2. The method of claim 1 wherein extending further comprises including a version element in the presence information, the version element defining a version of the suite of services.

3. The method of claim 1 wherein extending further comprises including a description element in the presence information, the description element being a human-readable string of characters that provides information about the suite of services.

4. The method of claim 1 wherein the suite of services is the Rich Communications Suite (RCS) as specified by Global System of Mobile communications Association (GSMA).

5. A non-transitory computer readable medium having instructions stored thereon, the instructions being configured to cause performance of the method set forth in claim 1.

6. A network device comprising:
a processor executing a presence server that is configured to perform the operations of:
extending presence information by including a service identifier element in the presence information, the service identifier element identifying a suite of services; and
transmitting to a watcher, after the extending, the presence information that includes the service identifier element.

7. The network device of claim 6 wherein the operation of extending further comprises including a version element in the presence information, the version element defining a version of the suite of services.

8. The network device of claim 6 wherein the operation of extending further comprises including a description element in the presence information, the description element being a human-readable string of characters that provides information about the suite of services.

9. The network device of claim 6 wherein the suite of services is the Rich Communications Suite (RCS) as specified by Global System of Mobile communications Association (GSMA).

10. A method comprising:
electronically publishing presence information associated with a presentity to a presence server, the presence information including a service identifier element that identifies a suite of services used by the presentity.

11. The method of claim 10 wherein the presence information further includes a version element defining a version of the suite of services.

12. The method of claim 10 wherein the presence information further includes a description element that is a human-readable string of characters that provides information about the suite of services.

13. The method of claim 10 wherein the suite of services is the Rich Communications Suite (RCS) as specified by Global System of Mobile communications Association (GSMA).

14. An electronic device comprising:
a processor executing a presentity agent configured to perform an operation of electronically publishing presence information associated with a presentity to a presence server, the presence information including a service identifier element that identifies a suite of services used by the presentity.

15. The electronic device of claim 14 wherein the presence information further includes a version element defining a version of the suite of services.

16. The electronic device of claim 14 wherein the presence information further includes a description element that is a human-readable string of characters that provides information about the suite of services.

17. The electronic device of claim 14 wherein the suite of services is the Rich Communications Suite (RCS) as specified by Global System of Mobile communications Association (GSMA).

18. A method comprising:
receiving, at a watcher, presence information from a presence server, the presence information including a service identifier element identifying a suite of services.

19. The method of claim 18 wherein the presence information further includes a version element, the version element defining a version of the suite of services.

20. The method of claim 18 wherein the presence information further includes a description element, the description element being a human-readable string of characters that provides information about the suite of services.

21. The method of claim 18 wherein the suite of services is the Rich Communications Suite (RCS) as specified by Global System of Mobile communications Association (GSMA).

22. An electronic device comprising:
a processor executing a watcher agent configured to perform an operation of receiving presence information from a presence server, the presence information including a service identifier element identifying a suite of services.

23. The electronic device of claim 22 wherein the presence information further includes a version element defining a version of the suite of services.

24. The electronic device of claim 22 wherein the presence information further includes a description element that is a human-readable string of characters that provides information about the suite of services.

25. The electronic device of claim 22 wherein the suite of services is the Rich Communications Suite (RCS) as specified by Global System of Mobile communications Association (GSMA).
